(19) United States
(12) Patent Application Publication
(10) Pub. No.: US 2026/0041083 A1
(43) Pub. Date: Feb. 12, 2026

(54) Enclosed mouse trap

(71) Applicant: Dean Paul Kim, Modbury (AU)

(72) Inventor: Dean Paul Kim, Modbury (AU)

(21) Appl. No.: 19/100,192

(22) PCT Filed: Jun. 19, 2023
(86) PCT No.: PCT/AU2023/050546

§ 371 Date: Jan. 31, 2025

(30) Foreign Application Priority Data
Aug. 1, 2022 (AU) 2022902150
Jun. 19, 2023 (WO) PCT/AU2023/050546

(51) Int. Cl. A01M 23/08; A01M 23/04; A01M 23/18

(52) U.S. Cl. CPC A01M 23/08; A01M 23/04; A01M 23/18

(57) ABSTRACT

An enclosed mouse trap consists of a lid-shaped container, a bucket container, a tunnel-shaped bridge, and an outer container. The lid-shaped container has one or two planks with fulcrum fitted on the floor, and it allows mice to falls into the bucket container below. The lid-shaped container has one or two short tunnel-shaped entrances each fitted with a one-way swing door providing an entrance for mice to enter the lid-shape container. Each entrance of the lid-shaped container connects with the tunnel-shaped bridge which has the same one-way swing door fitted within. The outer container has three tunnel-shaped entrances each fitted with the same one-way swing door. The lid-shaped container, the bucket container, and the tunnel-shaped bridge are all fitted within the outer container

### BACKGROUND OF THE INVENTION

### 1. Field of the Invention

The present invention relates to an animal trap and more particularly to a bucket based mouse trap.

### 2. Description of the Background Art

Conventional bucket based mouse traps have consisted of a bucket container having an open top with a fitted device in the form of a slippery cylindrical bridge mounted across a bucket container or in the form of a plank with fulcrum mounted on the edge of or on the top of a bucket container.

Conventional bucket-based mouse traps also need a bridge which enables a mouse to climb up the bucket from the ground. A mouse walks on a bridge from the ground, and then walks up to the edge of the bucket. Then the mouse walks towards baits or food sources which are located at the far end of the bucket from where the bridge is connected. Therefore, the mouse must walk on a cylindrical bridge or a plank fitted with fulcrum to get to the baits.

In the case of a traps fitted with a roller or slippery cylindrical bridge over a bucket container, mice may fall into the bucket container below as the mice walk on a roller or a cylindrical bridge to get to the baits. In the case of a trap fitted with a plank over a bucket container, mice may fall into the bucket container below as the plank pivot downward due to the weight of the mice tilting the plank at fulcrum as the mice advance toward baits located at the far end of the plank.

However, current bucket-based traps become less effective shortly after their use because some wary mice get to escape the traps. Therefore, some mice get to live and tell others of their own experience with the traps the mice escaped from.

Mice are naturally wary of new objects, in other words, mice are cautious creature. Some mice may not want to walk on a slippery cylindrical bridge or walk on a flank with fulcrum; therefore, some mice may get to live and to warn other mice the danger of the trap the mice had encountered. Once mice learn to associate the trap with danger, the mice will avoid the trap and may warn other mice about the danger of the trap the mice had encountered. That is why open bucket-based traps become less effective over time.

Bucket-based traps can cause wary mice to escape due to their design flaws. It is because the existing bucket-based traps allow mice to escape from the traps. In other words, their design flaws allow wary mice to walk out of the traps even after mice entered the trap including the bridge connected to the traps.

This invention address the short-comings of current bucket based mouse traps which mice can escape. Current existing mouse traps have reduction in their effectiveness over time which are caused by some of the mice gets to live and to warn other mice about the traps they have encountered.

This invention is made to prevent mice from escaping the trap once mice enter the trapping devices, including the bridge connecting the ground level to the trap. In addition, although this is specifically designed to trap mice, this inventive device can be used to trap other animals.

### SUMMARY OF THE INVENTION

The technical features essential to the way of this invention works are the following:

An enclosed bucket based trap comprising:

A bucket container; and a lid-shaped container having a circular, a rectangular, or a square-shaped which is adapted to fit a circular, a rectangular, or a square-shaped bucket container respectively; and

The lid-shaped container having outer wall in all sides except one or two entrances, in a preferred embodiment, on the side walls rather than the roof so that mice are easier to get inside the trap; and the entrance of the lid-shaped container for mice to enter through is a short-tunnel-shaped structure on the side walls of the lid-shaped container; and

The lid-shaped container has one or two entrances. Each entrance is a short tunnel-shaped structure located on the side walls of the lid-shaped container. Each entrance has a simple one-way mechanical swing door fitted within its tunnel-shaped structure. The entrance fitted with a simple one-way swing door is a part of the lid-shaped container; and

The short tunnel-shaped structure fitted with one-way swing door is called a connector. The connector is a part of the lid-shaped container, and it connects with a tunnel-shaped bridge. Each connector has a simple push, twist, and click interlocking mechanism which enables connection with the tunnel-shaped bridge; and

The lid-shaped container has one or two planks with fulcrum fitted onto its floor. Each plank has step-like features on its edges which results in improved sealing effects between the gaps along the floor of the lid-shaped container and the plank. The step-like features along the edges of plank help to minimise unpleasant odour escaping from the bucket container below; and

The lid-shaped container has internal side wall along the floor outlining the fitting space for one or two planks. The internal side wall guides mice to walk on the plank fitted with fulcrum so that mice fall into the bucket container below as mice approach toward the baits; and

The internal side wall start from the entrance of the lid-shaped container, the connector, to the distal end of plank. The height of the internal side wall extends from the floor to the ceiling of the lid-shaped container. The internal side wall prevents mice from having any other alternative pathways except going forward and walking on the plank to reach the food source which is located at the far end of the internal side wall; and

Bait is placed at the distal end of the internal side wall which is located distal to the end of planks on the floor of the lid-shaped container; and

The lid-shaped container connects with the tunnel-shaped bridge(s) via its connector(s). The lid-shaped container is used with an outer container. The lid-shaped container, a bucket container, and the tunnel-shaped bridge are all fitted within the outer container; and

The outer container has three tunnel-shaped entrances fitted on its three out of four side walls. It is to maximise the number of entrance for mice to enter whether it is placed against wall or placed against wall in corner; and

Each tunnel-shaped entrance of the outer container is fitted with the same simple one-way mechanical swing door which allows mice to get into the atrium of the outer container. Then the mice can continue to enter into the tunnel-shaped bridge and then the connector of the lid-shaped container. Then the same mice walk on the planks with fulcrum fitted on the floor of the lid-shaped container. The internal side wall of the lid-shaped container guides the mice to walk on the plank. The same mice eventually falls into a bucket container below as the mice advance toward the baits at the distal end of the internal side wall of the lid-shaped container; and

All three different tunnel-shaped structures; the three tunnel-shaped entrances of the outer container, the tunnel-shaped bridge(s), and the connector(s) of the lid-shaped container, have the same simple one-way mechanical swing doors fitted within each tunnel-shaped structure which allows mice to enter but not to leave. It is because the swing doors have been set up in a way so that the simple one-way mechanical swing door opens in one direction only when mice push it as mice advance through each tunnel-shaped structures. Each simple one-way mechanical swing door opens as mice push it within each tunnel-shaped structure due to particular ways of setting up the simple one-way mechanical swing door within the tunnel-shaped structures. The tunnel-shaped structures includes the three tunnel-shaped entrances of the outer container, the tunnel-shaped bridge(s), and the connector(s) of the lid-shaped container; and

There are two ways of setting up the one-way mechanical swinging doors which make each door to swing open in one direction only when mice push the swing door. At the same time such setting up of swing doors prevents mice from pushing the door swing open in the other direction. It is because the swing doors are either set at an angle within the tunnel wall or set against a step or bump-like structure or features within its tunnel wall. Therefore, mice cannot push the door swinging open in the opposite direction to get out in each separate stage of the enclosed-trap container; the connector(s) of the lid-shaped container, the tunnel-shaped bridge(s), and the tunnel-shaped entrances of the outer container; and

By setting each swing door at an angle within each tunnel-shaped structure, it causes the swinging door to have a larger surface area than the cross sectional area of its tunnel structure; and thus, it makes each swing door to open in one direction only when it is pushed by mice but not in the opposite direction; and

In addition, a compartment under the floor of the lid-shaped container can store odour absorbing agents, like baking powders, to minimised the odour of dead mice in the bucket container below; and

The lid-shaped containers have been designed in a way which can be used with or without the outer containers. Even without the outer container, this innovative mouse trap is built in a way that mice cannot get out of the trap once the mice enter the trap including the tunnel-shaped bridge connecting the ground level to the lid-shaped container. It is because the tunnel-shaped bridge(s) is fitted with the same one-way mechanical swing door within its tunnel. The tunnel-shaped bridge(s) and the connector(s) of the lid-shaped container both are fitted with the same simple one-way mechanical swing door within its tunnel-shaped structures as described above; and

The outer container will be housing all the above; the lid-shaped container with its connector(s), a bucket container, and the tunnel-shaped bridge. The outer container has three separate entrances. Each entrance is located on three out of four side walls of the outer container; and

Each entrance of the outer container is positioned in a way to allow two or three different entrances for mice to enter the outer container even if it is placed against wall or against wall in corner. This design increases the likelihood of catching more mice compare to the outer container with one or two entrances; and

Each entrance of the outer container has a tunnel-shaped structure fitted with the same simple one-way mechanical swing door which allows mice to get in but not to get out of the tunnel-shaped structure once mice pass through the swing door. Therefore, once mice get into the tunnel-shaped entrances of the outer container, the mice will have no other option but moving forward and to enter the atrium of the outer container. The atrium of the outer container has the lid-shaped container connected to the tunnel-shaped bridge and a bucket container; and

For example, once mice get inside of the outer container via the tunnel-shaped entrances fitted with the simple one-way mechanical swing door, the mice have no way of getting out but trapped in and can only move toward the atrium of the outer container; and

Within the outer container fitted with the three tunnel-shaped entrances, there are the lid-shaped container, a bucket container, and a simple bridge or the tunnel-shaped bridge; and

The tunnel-shaped bridge enables mice to climb up the trap from the ground level and to enter the lid-shaped container via the connector. If the above trap has the outer container then the lower end of the tunnel-shaped bridge will be located on the floor of the atrium of the outer container. If the above trap has the outer container fitted with the tunnel-shaped entrances which has the same one-way mechanical swing doors fitted within, then a simple bridge may be sufficient rather than having the tunnel-shaped bridge fitted with the one-way swinging door. However, if the trap is to be used without the outer container, then the lid-shaped container would be more effective when it is fitted with the tunnel-shaped bridge(s) which has one-way swing door fitted within to prevent mice from escaping the traps including the tunnel-shaped bridge(s); and

The outer container has three tunnel-shaped entrances which enables mice to get in but the way out is prevented by the same simple mechanical swing door fittings within the three tunnel-shaped entrances. It enables mice to push the swing door open as the mice enter the entrances, but it does not allow mice to escape due to it does not swing opens when the mice want to get out. The mice cannot get out because the tunnel-shaped entrances of the outer container have the same simple mechanical swing door built-in within its three tunnel-shaped entrances. Each swing door opens toward the trap when mice push it, but it does not swing open when mice try to escape. Therefore, this outer container which has three tunnel-shaped entrances with the same simple mechanical swing door built-in would prevent mice from escaping. In other words, this trap will prevent mice from escaping and warming others about the danger of the trap mice had encountered; therefore, it will remain to be effective compare to other traps in the market.

This bucket-based mouse trap is built in a way that mice cannot escape the trap once mice set foot onto the trap including the bridge connection to the lid-shaped container and the outer container. This is the main difference compare to other existing bucket-based mouse trap which allows mice to leave the trap after setting their foot on the trap.

The lid-shaped container, a bucket container, the tunnel-shaped bridge(s), and the tunnel-shaped entrances of the outer container are all fitted within the outer container. The outer container has three-tunnel-shaped entrances built-in. Each of the entrance fitted on the outer container has the same simple one-way mechanical swing door built-in within each of the three tunnel-shaped entrances.

### BRIEF DESCRIPTION OF DRAWINGS

FIG. 1 is a perspective view of the outer container;

FIG. 2 is a perspective view of the tunnel-shaped entrance of the outer container fitted with one-way swing door within its tunnel-shaped entrance;

FIG. 3 is a perspective view of the outer container fitted with three tunnel-shaped entrances which have the one-way swing door built-in within its tunnel wall;

FIG. 4 is a perspective view of the connector which is a part of the lid-shaped container. It shows the short tunnel-shaped structure with the one-way swing door fitted within its tunnel;

FIG. 5 is a perspective view of the flank with fulcrum. It has wider step-like features along the plank to cover the gaps between the floor of the lid-shaped container and the plank;

FIG. 6 is a perspective view of the lid-shaped container, a bucket container and an optional size-adapter plate. FIG. 6a is a perspective view of the lid-shaped container having one connector and one plank with fulcrum fitted on the floor. FIG. 6b is a perspective view of the lid-shaped container having two connectors each having its own plank with fulcrum fitted on its floor;

FIG. 7 is a perspective view of the lid-shaped container shown in FIGS. 6a and 6b in more detailed view;

FIG. 8 is a perspective view of various configurations of the lid-shaped container in a step-wise assembled view;

FIG. 9 is a perspective view of the outer container having three tunnel-shaped entrances fitted on three out of four side walls of the outer container. It also shows the outer container having the lid-shaped container with a bucket container within. The lid of the outer container and the bridge were not shown for simplification of the diagram;

FIG. 10 is a perspective view of the tunnel-shaped bridge fitted with the one-way swing door at its base;

FIG. 11 is a perspective view of the lid-shaped container, a bucket container and the tunnel-shaped bridge(s) assembled together without the outer container. FIG. 11a is a perspective view of the lid-shaped container which has one connector with one connecting bridge, either a simple bridge or the tunnel-shaped bridge fitted with the simple one-way swing door within its tunnel wall. FIG. 11b is a perspective view of the lid-shaped container which has two connectors each having the tunnel-shaped bridge fitted with the one-way swing door within its tunnel wall.

### DESCRIPTION OF THE PREFERRED EMBODIMENTS OF THE INVENTION

The following descriptions are used for sake of clarity and are intended for reference only to this invention for illustration in the drawings. The following descriptions are not intended to define or limit the scope of this invention.

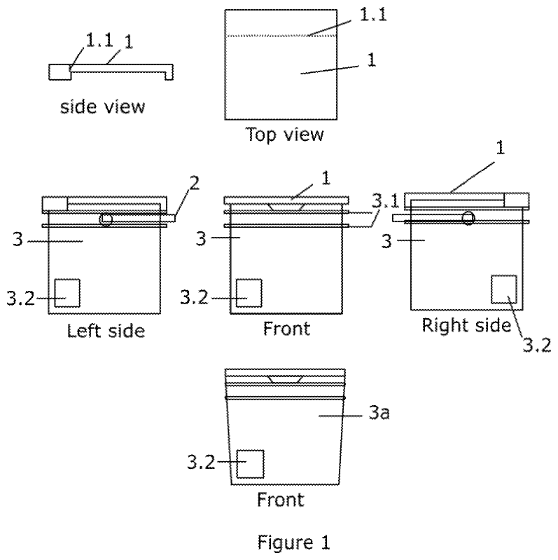

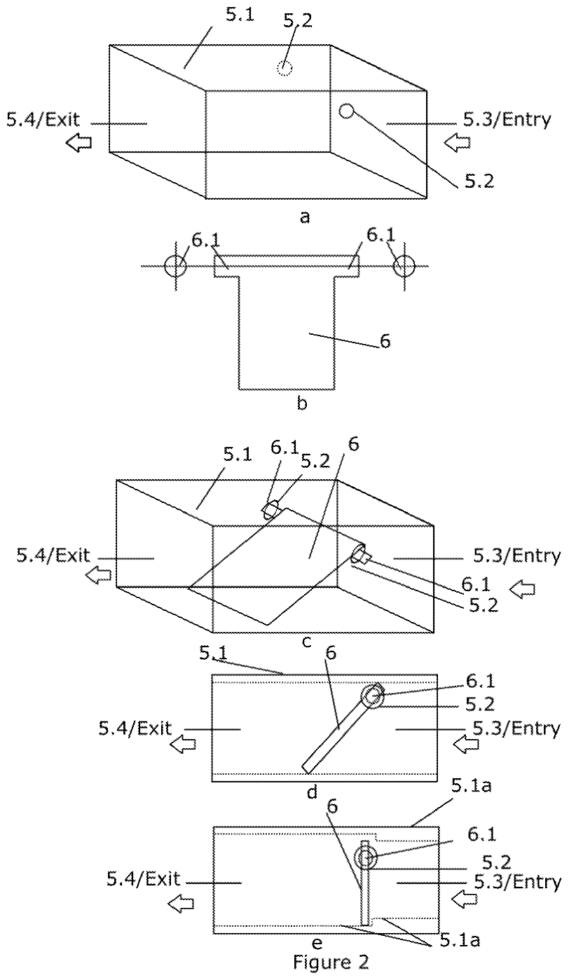

FIG. 1 is a perspective exterior view of the outer container 3. The outer container includes the three tunnel-shaped entrances (see FIG. 2) fitted against the side wall of the container. (3a represents the same outer container as shown, but it has tapered configuration along the side wall). For the simplicity we will call both the outer containers 3 and 3a as 3. The outer container 3 has three entrances 3.2 at the ground level, one entrance each on three side walls out of four side walls.

### Outer container 3 is made of the following parts;

A lid 1; and

The lid folding line 1.1 enables a partial opening of the lid; and it enables people to take look inside of the container without removing the whole lid; and it enables a person to remove inner traps without taking the whole lid 1 off, and

A handle 2 and ridges 3.1 along the container wall provide additional rigidity of the outer container 3; and

Each entrance 3.2 on three out of four side walls of the outer container 3 provides entry point in which mice can enter the outer container 3. For this illustration purpose, we have chosen the square-shaped entrances; however, it can be also round or oval-shaped entrance on the side wall of the outer container 3.

FIG. 2 is a perspective view of the tunnel-shaped entrance 5 which is a part of the outer container 3 (see FIGS. 1, 2, and 3). The tunnel-shaped entrance 5 (see FIGS. 2c, 2d and 2e) is made of a tunnel-shaped structure 5.1 (see FIG. 2a) fitted with a simple one-way mechanical swing door 6 (see FIG. 2b).

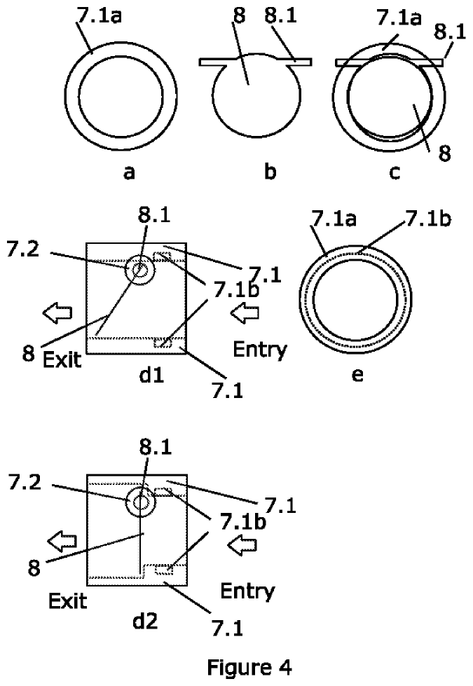

The tunnel-shaped structure 5.1 (see FIG. 2a) can be in various sizes and shapes including square, rectangular, circular, or oval shaped. Cross-sectional shape of the tunnel-shaped structure determines which one-way swing door 6 to be fitted within the tunnel-shaped structure 5.1. In this example, we showed a square-shaped tunnel structure 5.1 fitted with a square-shaped one-way swing door 6. In FIG. 4 we showed the same but with a round-shaped tunnel structure 7.1 fitted with a circular or oval-shaped one-way swing door 8.

The tunnel-shaped structure 5.1 has tunnel-shaped wall with one entry 5.3 and one exit 5.4 at the opposite ends. The tunnel-shaped structure 5.1 has a pair of holes 5.2 on its tunnel-shaped wall which provides fitting spaces for pivoting cylindrical tabs 6.1 of the one-way swing door 6.

The one-way swing door 6 has two components (see FIG. 2b); a main body and a pair of pivoting cylindrical tab 6.1 (see FIG. 2b). The main body of the swing door 6 has a flattened surface covering the cross-sectional areas of the tunnel-shaped structure 5.1. The tabs 6.1 of the one-way swing door have the cylindrical structures.

There are two ways of setting up the one-way swing door 6 depends on the types of tunnel-shaped structure 5.1 are used. If the tunnel-shaped structure 5.1 has no step-like or bump-like feature(s) within its wall (see FIG. 2d), then the one-way swing door 6 is set at an angle within the tunnel-shaped structure 5.1, and the lower ends of the swing door rests on the interior surface of the tunnel-shaped structure 5.1. Such setup enables the one-way swing door to open when mice push it in the entry to exit direction only. (see FIGS. 2c and 2d). In other words, such setup prevents mice from pushing the one-way swing door to be opened in the opposite direction; exit to entry direction.

If the tunnel-shaped structure 5.1 has a step-like or bump-like feature(s) within its wall 5.1a, then the one-way swing door is placed directly against the step-like or bump-like feature(s) within the wall as shown on FIG. 2e. Such setup enables the swing door to open when mice pushes it in the entry to exit direction only. In other words, such setup prevents mice from pushing the one-way swing door to be opened in the opposite direction; exit to entry direction.

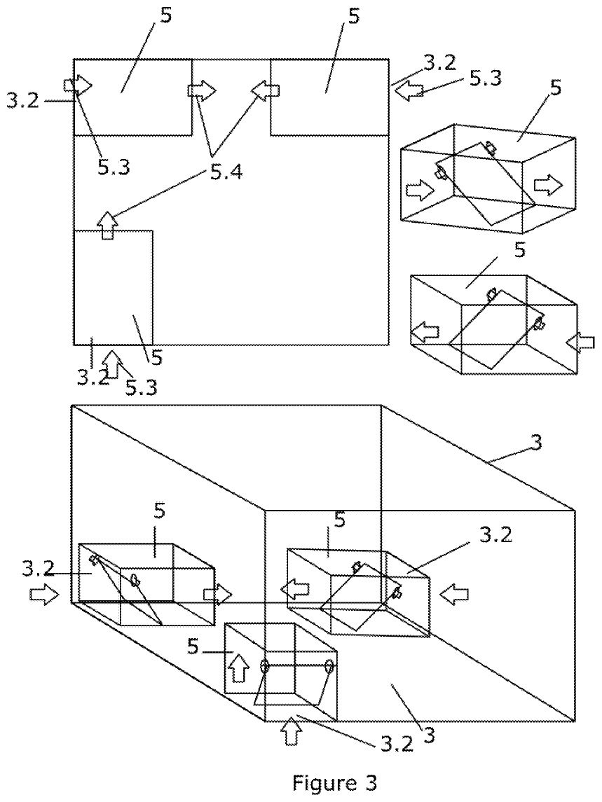

FIG. 3 is a perspective view of the outer container 3 with all three tunnel-shaped entrances 5 fitted on the outer container 3. All three entry ends 5.3 of the tunnel-shaped entrances 5 are facing the outer container's entrance 3.2. And all three exit ends 5.4 of the tunnel-shaped entrances 5 are facing the atrium of the outer container 3. Such placement of all three tunnel-shaped entrances 5 as described above enables mice to pass through the outer container 3 via the tunnel-shaped entrances 5 and then enter the atrium of the outer container 3. At the same time, the same setting of the tunnel-shaped entrances 5 on the outer container 3 prevents mice from escaping the traps once mice go through the one-way swing door 6 of the tunnel-shaped entrances 5.

The Arrows on the diagrams show the perspective movements of mice going through each one of the three entrances 3.2 of the outer container 3. Mice then push through one of the three one-way swing door 6 and continue to go through the tunnel-shaped entrance 5. Then mice come out of the exit end 5.4 of the tunnel-shaped entrance 5 and eventually enter the atrium of the outer container 3.

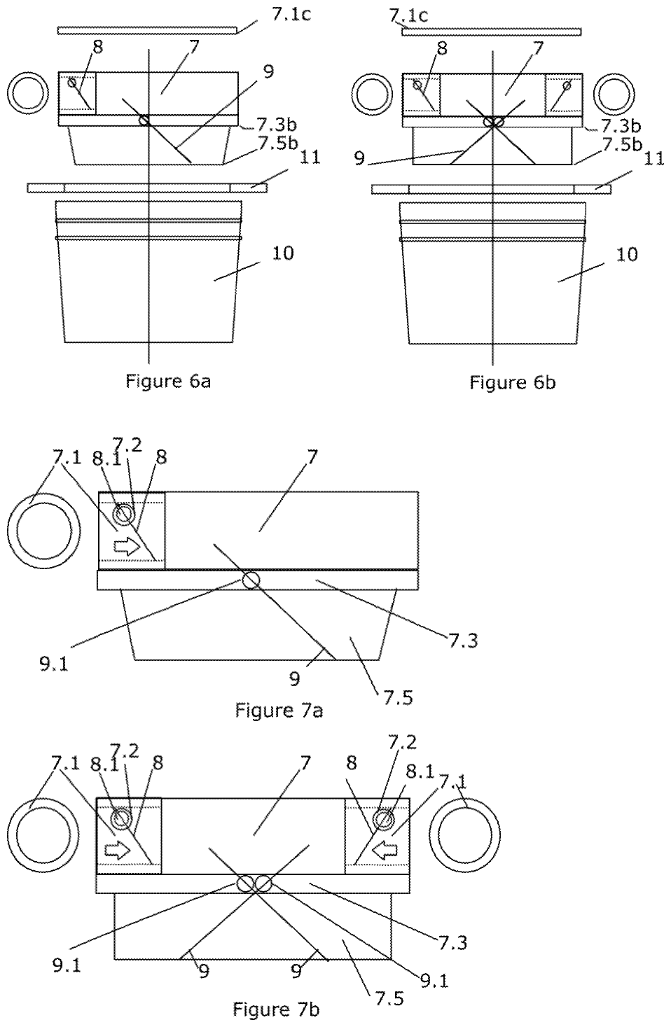

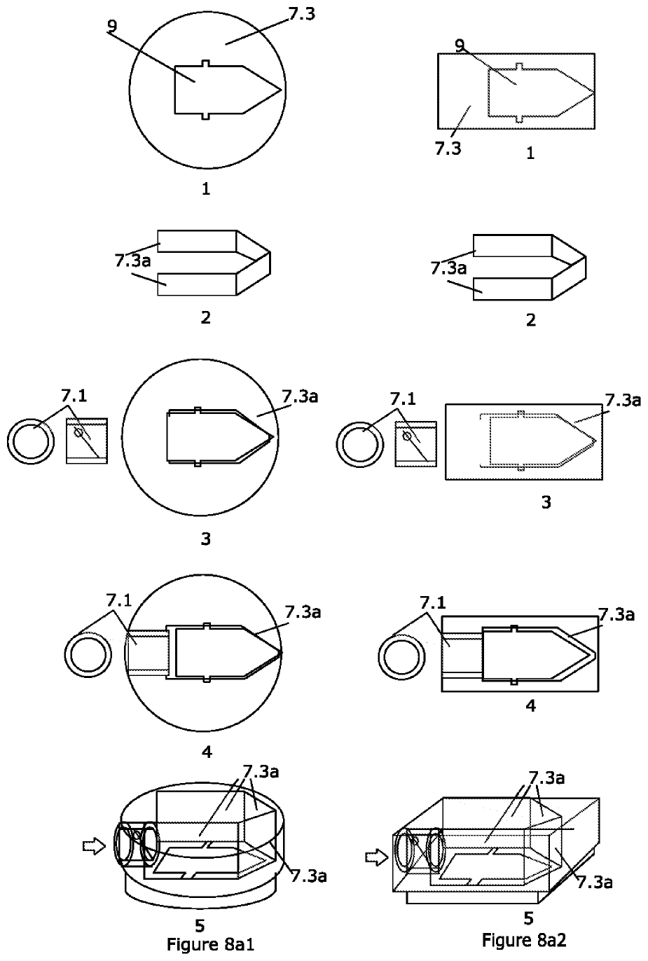

FIG. 4 is a perspective view of the connector 7.1 which is a part of the lid-shaped container 7 (see FIGS. 6 and 7). The connector 7.1 (see FIG. 4) is made of a short tunnel-shaped structure 7.1a fitted with a simple mechanical one-way swing door 8. The connector 7.1 is a short tunnel-shaped entrance within the wall of the lid-shaped container 7, so that mice can walk through the short-tunnel shaped entrance and get inside of the lid-shaped container 7.

The connector 7.1 is made of the following parts;

A short tunnel-shaped structure 7.1a has a tunnel-shaped wall with one entry and one exit at the opposite ends. The short tunnel-shaped structure 7.1a has a pair of holes 7.2 on its tunnel-shaped wall which provides fitting spaces for pivoting cylindrical tabs 8.1 of the one-way swinging door 8. The connector is made of the short tunnel-shaped structure 7.1a fitted with the one-way swing door 8.

FIG. 4a is a perspective cross-sectional view of the short tunnel-shaped structure 7.1a which is the main component of the connector 7.1. (see FIGS. 6 and 7) The connector 7.1 provides mice with one-way entrance into the lid-shaped container 7. FIG. 4b is a perspective front view of the one-way swing door 8 with a pair of cylindrical tabs 8.1. It is essentially the same as the one-way swing door 6 shown on FIG. 2b. Both swing door 6 and 8 are the same except each has different shaped bodies; square or rectangular shaped versus round or oval shaped. The one-way swing door 8 has two components; the main body of swinging door 8, and its pivoting cylindrical tab 8.1 as shown. Its tab 8.1 has a cylindrical structure so that it helps with pivoting at its axis while the body 8 has a flattened surface covering the cross-sectional area of the tunnel-shaped structure 7.1a.

FIG. 4c is a perspective cross sectional view of the connector 7.1. The connector 7.1 is made of a short tunnel-shaped structure 7.1a with one-way swinging door 8 anchored through a pair of holes 7.2 on the short tunnel-shaped structure 7.1a. The pair of holes 7.2 provides fitting spaces where a pair of tabs of one-way swing door can pivot freely when mice push the swing door from an entry to exit direction.

There are two ways of setting up the one-way swing door depends on the types of short tunnel-shaped structure 7.1a are used. This is the same set ups as described in FIG. 2. If the connector 7.1 has no step or bump-like feature(s) within its tunnel wall (see FIG. 4d1), then the one-way swinging door 8 is set at an angle within the tunnel-shaped structure 7.1a, and the lower edges of the swing door rests on the interior surface of the tunnel-shaped structure 7.1a. Such set up makes the door 8 can be swing open in one direction only from entry to exit (see FIG. 4d1). In other words such set up prevents mice from pushing the door swing open in the opposite direction.

If the short tunnel-shaped structure 7.1a has a step-like or bump-like feature or features within its wall, then the swing door 8 is placed directly against the step-like or bump-like feature(s) within the tunnel wall as shown on FIG. 4d2. Such placement enables the swinging door 8 to swing open when mice push the door 8 in the entry to exit direction only. And such set up prevents mice from pushing and swing open the door 8 in the opposite direction. Therefore, such set up as described above does not allow mice to escape from the lid-shaped container 7 once mice go through the one-way swing door 8 of the connector 7.1.

FIG. 4d1 is a perspective view of a longitudinal section of the short tunnel-shaped structure 7.1a fitted with the one-way swing door 8. The one-way swing door 8 is set at an angle with its lower edge resting on the interior surface of the connector 7.1. Above setting enables mice to push the swing door 8 open in one direction only; entering into the lid-shaped container 7 but not to get out of the lid-shaped container 7.

FIG. 4d2 is a perspective view of a longitudinal section of the short tunnel-shaped structure 7.1a fitted with the one-way swing door 8. The one-way swing door 8 is set directly against a step-like or bump-like feature(s) within the connector 7.1. This set up enables mice to push the door swing open as the mice enter into the lid-shaped container 7. However, the same set up does not allow mice to get out of the lid-shaped container because the set up prevents mice from swing the door open in the opposite direction.

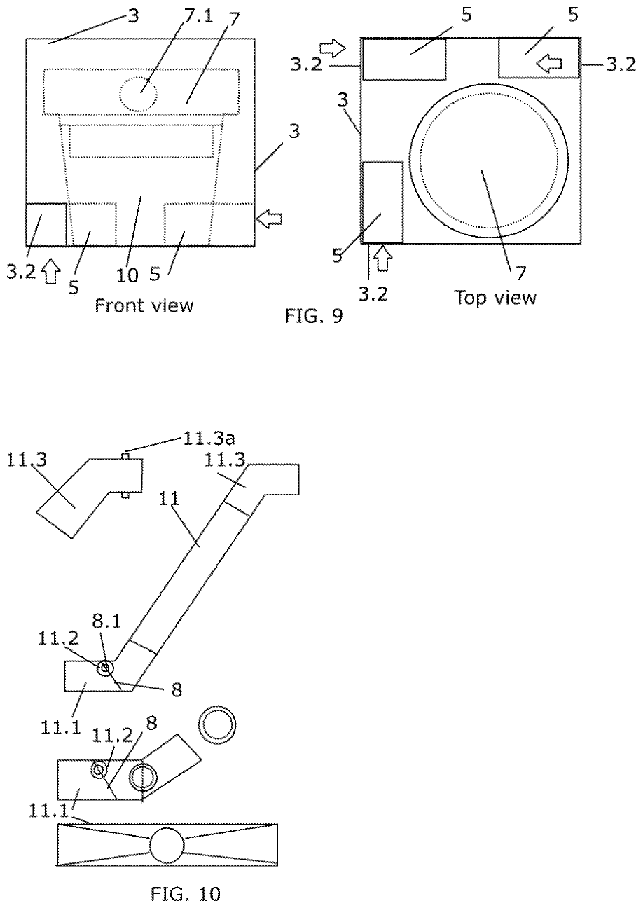

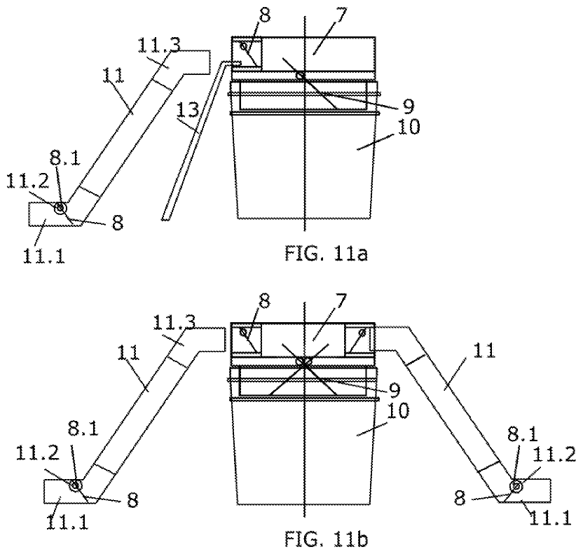

FIG. 4d1, 4d2 and 4e shows a perspective view of longitudinal and cross sections of the connector 7.1. The connector 7.1 has a simple interlocking mechanism 7.1b providing a simple secure way of connection with a bridge 11. A little grooves 7.1b within a connector enables a bridge to be securely connected to the connector 7.1 of the lid-shaped container 7. The connector 7.1 can be used to anchor a simple bridge which connects to the ground level. In addition, the connector 7.1 can be connected to the tunnel-shaped bridge 11 which has its own one-way swing door 8 fitted within its tunnel as shown on FIGS. 10, 11a and 11b.

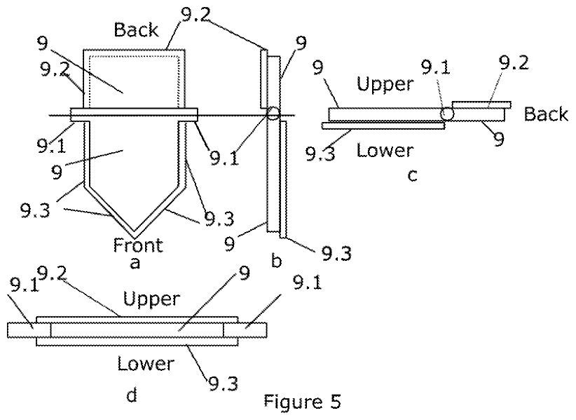

FIG. 5 is a perspective view of the plank with fulcrum in various angles of view. FIG. 5a is a perspective view from the top of the plank 9 with fulcrum 9.1. FIGS. 5b and 5c are perspective side views of FIG. 5a. FIG. 5d is a magnified perspective view of FIG. 5a from its front side.

The plank with fulcrum 9 is made of the following parts;

The plank 9 has a pair of cylindrical-shaped fulcrums 9.1 extending from the lateral sides of the plank. The plank also has a slightly wider and larger segment 9.2 covering the posterior half of the upper surface section of the plank. The same plank also has a slightly wider and larger segment 9.3 covering the anterior half of the underneath surface section of the plank. The two wider and larger segments 9.2 and 9.3, covering the anterior and posterior segments of the plank, are to minimise the unpleasant odour coming from underneath the floor of the lid-shaped container.

FIG. 6 is a perspective view of the lid-shaped container 7. The lid-shaped container 7 is adapted to fit a bucket container 10. The lid-shaped container 7 can be fitted directly on a bucket container if it can be fitted over a bucket container 10. The outer rim 7.3b of the lid-shaped container 7 enables it to be placed on a rim of bucket container 10. If the lid-shaped container cannot be fitted due to having a smaller diameter compared to a bucket container below, then it will need a size-adaptor plate 11. The optional size-adaptor plate 11 can be placed between the lid-shaped container 7 and a bucket container 10. The opening of the size-adaptor plate 11 is fixed so that it can fit the inner rim 7.5b of the lid-shaped container 7 while the size-adaptor plate sides can be adjusted to cover the rim of bucket container 10. The size of the adapter plate can be adjusted so that it can fit the same lid-shaped container 7 over various sized bucket containers 10.

7.1c is a removable lid-cover of the lid-shaped container; and

7.3b is an outer rim which is designed to be placed either on the rim of bucket container below or over the size-adapter plate 11; and

7.5b is an inner rim which is designed to be placed through a bucket container and the optional size-adaptor plate 11.

FIG. 7 is a perspective view of the lid-shaped container 7 in details;

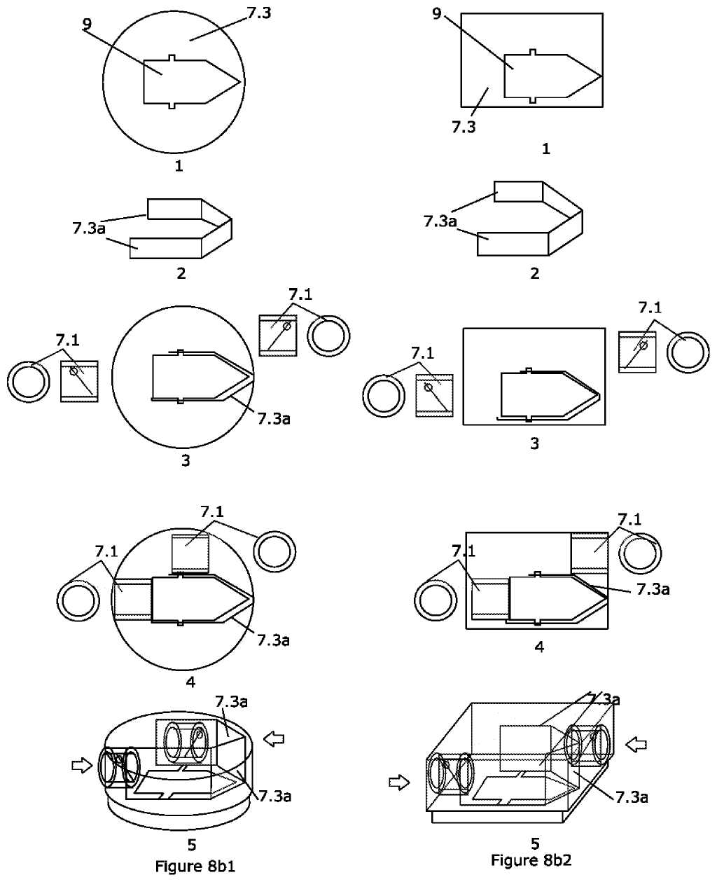

FIG. 6a and FIG. 7a are perspective view of the lid-shaped container 7 having one connector 7.1 fitted with one-way swing door 8, and one plank 9 with its fulcrum 9.1 fitted on the floor 7.3 of the lid-shaped container 7. FIG. 6b and FIG. 7b are perspective view of the lid-shaped container 7 having two connectors 7.1 each fitted with one-way swing door 8, and two planks 9 with its fulcrums 9.1 fitted on the floor 7.3 of the lid-shaped container 7. FIG. 8 is a perspective view of further details of the lid-shaped containers in various shapes and configurations.

The lid-shaped container 7 is made of the following parts; (see FIGS. 7a, 7b and FIG. 8) The connector 7.1 is fitted with the one-way swing door 8 providing one-way entrance into the lid-shaped container 7 (see FIG. 4). 7.3 represents the floor of the lid-shaped container 7. The floor 7.3 has space for one or two planks with fulcrums to be fitted on the floor space; see FIG. 8. It enables the plank to be tilted at its fulcrum as mice advance toward the front end of plank as mice try to reach baits located between the distal ends of internal side wall 7.3a of the lid-shaped container 7. The floor 7.3 of the lid-shaped container also has a compartment storage space 7.5 for baking powder to be stored underneath the floor so that baking powder can absorb unpleasant odour in the bucket container below. The floor of the lid-shaped container also has the internal side wall outlining the plank with fulcrum between the connector and the distal ends of the plank. The height of the internal side wall extends from the floor to the roof of the lid-shaped container along the plank fitting space.

FIG. 8 is a perspective view of various shapes and configurations of the lid-shaped containers in detailed diagrams;

FIG. 8a1 is a perspective view of a single plank with one connector fitted on a circular lid-shaped container; and

FIG. 8a2 is a perspective view of a single plank with one connector fitted on a rectangular or square lid-shaped container; and

FIG. 8b1 is a perspective view of a single plank with two connectors fitted on a circular lid-shaped container; and

FIG. 8b2 is a perspective view of a single plank with two connectors fitted on a rectangular or square lid-shaped container; and

FIG. 8c1 is a perspective view of two planks with two connectors fitted on a circular lid-shaped container; and

FIG. 8c2 is a perspective view of two planks with two connectors fitted on a rectangular or square lid-shaped container.

The following statements explain the further details of FIG. 8 in a step-wise assembled views.

FIG. 1 (of FIG. 8) shows the floor diagram fitted with plank(s) with fulcrum(s) 9 on the floor 7.3 of the lid-shaped container 7. It is shown without the roof covering and the outer side wall of the lid-shaped container; and

FIG. 2 (of FIG. 8) shows the internal side wall 7.3a of the lid-shaped container. The internal side wall is located between the connector to the distal end of plank along the floor of the lid-shaped container outlining the fitting space for the plank(s). Essentially, the internal side wall outline the plank(s) fitting space along the floor of the lid-shaped container. Plank fitting space is outlined by the internal side wall starts from the distal end of connector(s) 7.1 where mice come through and along the internal side wall of the lid-shaped container 7. The purpose of having the internal side wall 7.3a is to guide mice to walk on the plank(s) as mice come out of the connector(s) 7.1 and then on to the floor of the lid-shaped container mainly occupied by the plank(s) so that mice fall into a bucket below. The height of the internal side wall 7.3a extends from the floor to the ceiling of the lid-shaped container 7, and it extends from its connector(s) 7.1 to the distal end of the tip of plank(s) 9. The internal side wall 7.3a has a baits storage compartment 7.3b between the distal end of plank(s) and the distal end of the internal side wall 7.3a; and

FIG. 3 (of FIG. 8) shows the internal side wall 7.3a and the plank(s) with fulcrum(s) fitting on the floor of the lid-shaped container without the roof and the outer side wall of the lid-shaped container. It also shows the connector(s) 7.1 fitted with the one-way swing door 8 forming the one-way entrance for mice to enter the lid-shaped container 7; and

FIG. 4 (of FIG. 8) shows the connector(s) 7.1 fitted with the one-way swing door 8 assembled onto the lid-shaped container 7. The floor between the outer side wall and the internal side wall has optional features of having see-through floor, so that people can see the content beneath the floor without lifting the lid-shaped container to see what is in the bucket below. The diagram is shown without the roof covering and the outer side wall of the lid-shaped container; and

FIG. 5 (of FIG. 8) shows three dimensional view of various configurations and shapes of the lid-shaped containers 7 reflective of each preceding above figures. (FIG. 5 of FIG. 8c1 and FIG. 8c2 did not show the internal side wall 7.3a along the outer edge of plank(s) in order to clearly show the floor design of the lid-shaped container 7. The internal side wall of the lid-shaped container 7.3a designs can be clearly seen on the above diagrams.

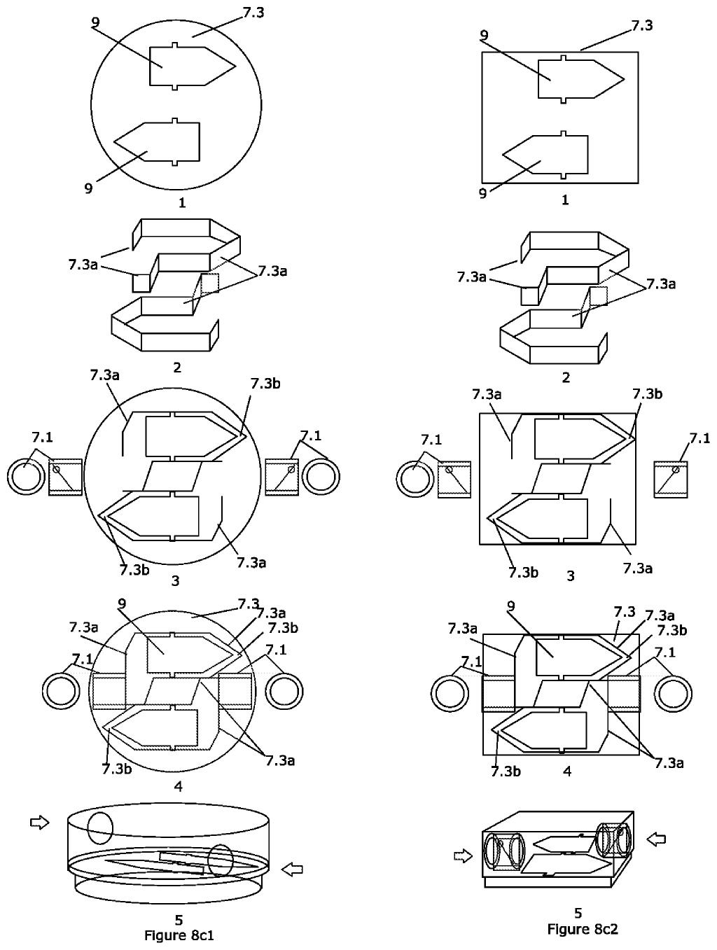

FIG. 9 is a perspective view of the lid-shaped container 7 with a bucket container 10 housed within the outer container 3. The outer container has three tunnel-shaped entrances 5 on three out of four side walls (see FIG. 3). The FIG. 9 shows the front view and the top view without the lid 1 of the outer container 3. It has a bridge which provides a connection from the ground level of atrium of the outer container 3 to the connector 7.1. The connector 7.1 is used to connect with a simple open bridge or the tunnel-shaped bridge. The both types of bridges provide means of an entry into the lid-shaped container 7 via the connector 7.1 from the atrium of the outer container. For simplicity the bridge connecting the atrium to the connector 7.1 was not shown in this figure.

Mice can go into one of the three entrances 3.2 of the outer container 3. Then mice go through the tunnel-shaped entrance 5 pushing through the one-way swing door 6 and then get to the atrium of the outer container 3. Then mice go up the bridge which provides link between the atrium and the connector 7.1 of the lid-shaped container 7. Then mice go through the connector 7.1 fitted with the one-way swing door 8, then mice walk on the plank 9 fitted on the floor 7.3 of the lid-shaped container 7. As the mice advance toward the distal ends of plank to get to baits, the plank tips over, and the mice fall into the bucket container 10. This innovative trap is designed in a way so that mice cannot escape once mice pass through one of the three one-way swing doors 6 of the tunnel-shaped entrances of the outer container 3. The reason mice cannot get out once go through one of the three one-way swing doors 6 of the tunnel-shaped entrances 5 is because of how the one-way swing doors 6 are positioned within each tunnel-shaped entrance 5.1 as describe in FIG. 2. In addition, once mice go through the connector 7.1 fitted with one-way swing door 8, the mice cannot get out of the lid-shaped container 7. These arrangements provide traps in separate compartments so that mice cannot get out in each separate stages of traps. In addition, such set up of each stage of traps give the mice only option, moving forward into the lid-shaped container 7 and then falling into a bucket container 10 below.

FIG. 10 is a perspective view of a specifically designed tunnel-shaped bridge 11 with a tunnel-shaped entrances 11.1 at the lower end of the tunnel-shaped bridge. It has the same one-way swing door 6 or 8 as seen in FIG. 2 and FIG. 4 respectively depending on whether the tube is square or round shaped. In this FIG. 10, a round tunnel-shaped bridge is demonstrated. It has an inter-locking mechanism 11.3a to securely connect to the connector 7.1 of the lid-shaped container. Distal ends 11.1 and proximal ends 11.3 of the tunnel-shaped bridge have similarity to a typical stick vacuum cleaner tube-shaped structures which enable rotation, swivel and tilting at its connecting parts. Lower distal ends of the tunnel-shaped bridge 11.1 has a broader base, like a typical distal vacuum cleaner ends which has a broader base then tapered toward central tube structure from its wide broad base, which helps to guide mice to enter the tunnel-shaped bridge.

The tunnel-shaped bridge 11 is made of the following parts;

The tunnel-shaped bridge 11 has a tunnel-shaped structure, like a typical stick vacuum tube-shaped structure. The distal end of the tunnel-shaped bridge 11.1 has a wider and broader base which has tapering toward a central tube structure from its broader base. It is like a typical vacuum cleaner distal ends which has tapering toward a central tube structure from its distal wider and broader base. In addition, the distal ends of tunnel-shaped bridge 11.1 can rotate, swivel and tilt just like the distal end part of a stick-vacuum cleaner.

The distal end of the tunnel-shaped bridge 11.1 has the one-way swing door 6 or 8, just like FIG. 2 and FIG. 4 respectively, depending on whether the bridge structure has square or round shaped respectively. The one-way swing door 8 in the tunnel-shaped bridge 11 allows mice to enter, but it prevents mice from escaping once it goes through the one-way swing door 8 of the tunnel-shaped bridge 11. A pair of holes 11.2 within the wall of 11.1 accommodates the tabs of the one-way swing door 8.1 onto the wall of the tunnel-shaped bridge. The setting of the one-way swing door has the same setting just like FIG. 2 and FIG. 4 so that it can be swing open when mice push the swing door in one-direction only. The proximal end 11.3 of the tunnel-shaped bridge 11 has a simple inter-locking mechanism 11.3a with the connector's interlocking counter parts 7.1b of the lid-shaped container 7. The simple interlocking mechanism used in the connection between the proximal end 11.3 of the tunnel-shaped bridge and the connector 7.1 utilises the same simple interlocking mechanisms which can be seen in various vacuum device.

FIG. 11 is a perspective view of two different configurations of the lid-shaped container 7 set up with a bucket container 10 and the bridge(s). It shows the lid-shaped container 7 with one or two connector(s) 7.1 having corresponding number of bridge(s) connecting the ground level to the connector(s) 7.1 of the lid-shaped container 7.

FIG. 11a shows the lid-shaped container 7 fitted with a simple bridge 13 or the tunnel-shaped bridge 11 fitted with one-way swing door 8 enabling mice to climb up from the ground level to the connector 7.1 of the lid-shaped container 7. FIG. 11b shows the lid-shaped container 7 with two connectors 7.1 fitted with each of its own the same tunnel-shaped bridges 11 which has the same one-way swing doors 8 within.

FIG. 11a is a perspective view of setting to be used with the outer-container 3 along with a simple bridge 13 or the tunnel-shaped bridge 11 fitted with the one-way swing door 8. FIG. 11b is a perspective view of setting to be used without the outer container 3. The lid-shaped container can have one or two connectors 7.1 each with its own tunnel-shaped bridge(s) 11 fitted with one-way swing door 8. If one of the connector 7.1 is not in use, then its entrance can be covered with a simple cap or plug.

What is claimed is:

1. An enclosed mouse trap is comprised of a lid-shaped container, a bucket container, a tunnel-shaped bridge(s), and an outer container. The lid-shaped container is adapted to fit over a bucket container. The lid-shaped container has one or two short tunnel-shaped entrances and one or two planks with fulcrum. The lid-shaped container also has a roof, a floor, an internal side wall, and an outer side wall. Each of the short tunnel-shaped entrances provides an entrance in which mice can enter the lid-shaped container. Each of the short tunnel-shaped entrances is located between the internal side wall and the outer side wall; therefore, it makes the two side walls to be contiguous. Each of the short tunnel-shaped entrances is fitted with a one-way swing door. Each of the short tunnel-shaped entrances fitted with the one-way swing door is called a connector of the lid-shaped container. The lid-shaped container has one or two connectors. Each connector of the lid-shaped container is fitted with the one-way swing door. The one-way swing door in each of the connectors provides one-way entrance for mice to enter the lid-shaped container which has baits within. Each connector of the lid-shaped container connects with a tunnel-shaped bridge. Each tunnel-shaped bridge has the same one-way swing door fitted within its tunnel-shaped structure. The side walls of the lid-shaped container are comprised of the internal side wall and the outer side wall. The internal side wall is located on the floor of the lid-shaped container outlining one or two planks fitting space. The purpose of having the internal side wall is to guide mice to walk on the plank after mice get inside the lid-shaped container via the connector. The internal side wall, the outer side wall, and the connector all together forms the contiguous enclosed wall of the lid-shaped container along with the roof and the floor covering except one or two planks fitting space. The lid-shaped container has one or two planks with fulcrum fitted on the floor depending on whether it has one or two connectors. Each plank has step-like features along its edges. The outer container has three tunnel-shaped entrances each fitted with the same one-way swing door found in the connectors and the tunnel-shaped bridges. The lid-shaped container, the bucket container, and the tunnel-shaped bridges are all fitted within the outer container. Each one-way swing door in the tunnel-shaped entrances of the outer container, the tunnel-shaped bridges, and the connectors allows mice to enter each stage of traps. At the same time, each of the same one-way swing doors prevents mice from escaping each corresponding stage of traps. The first stage of the enclosed mouse trap is mice entering the inside of the outer container via going through one of the three tunnel-shaped entrances fitted on three side walls of the outer container. The second stage of the enclosed mouse trap is the mice getting in and going up the tunnel-shaped bridge from the atrium of the outer container. The third stage of the enclosed mouse trap is mice entering the lid-shaped container via the connector and then walking on the plank with fulcrum fitted on the floor of the lid-shaped container while guided by the internal side wall. As mice advance toward the baits, the plank tilts; and mice fall into a bucket container below.

2. The enclosed mouse trap container according to claim 1, wherein the lid-shaped container has two side walls; the internal side wall and the outer side wall. The internal side wall is located along the floor of the lid-shaped container outlining the fitting space for one or two planks with fulcrum. The internal side wall starts from the connector of the lid-shaped container to the distal ends of planks. The height of the internal side wall extends from the floor to the roof of the lid-shaped container. The internal side wall is designed to guide mice to walk on the plank after mice emerge from the connector of the lid-shaped container. The outer walls are comprised of the removable roof, the floor, and the outer side wall. The outer side wall has one or two short tunnel-shaped entrances each fitted with one-way swing door; the connector(s). The floor of the lid-shaped container has one or two planks with fulcrum fitted on the floor.

3. The enclosed mouse trap container according to claim 1, wherein the lid-shaped container having the internal side wall and the outer side wall configurations to be round, rectangular, or square shaped. There is one or two short tunnel-shaped entrances between the internal side wall and the outer side wall of the lid-shaped container. The short tunnel-shaped entrance fitted with the one-way swing door is called the connector of the lid-shaped container. Each connector is fitted with the one-way swing door. Each connector is an entrance port for mice to enter into the lid-shaped container. Each connector of the lid-shaped container connects with the tunnel-shaped bridge. Therefore, mice can get into the lid-shaped container via going through the inside of the tunnel-shaped bridge(s) and then the connector.

4. The enclosed mouse trap container according to claim 1, wherein the lid-shaped container fitted with plank having a step-like features. The step-like features of plank provide improved sealing effects between the gaps along the floor of the lid-shaped container and the plank. The wider step-like feature compare to the plank is located lower surface of the plank pivoting downward anterior to the fulcrum while the wider step-like feature compare to the plank is located upper surface of plank pivoting upward posterior to the fulcrum.

5. The enclosed mouse trap container according to claim 1, wherein the floor of the lid-shaped container having a compartment underneath the floor for the storage of baking powder.

6. The enclosed mouse trap container according to claim 1, wherein the lid-shaped container has optional clear plastic parts along the roof of the container including the connectors. The floor of the lid-shaped container between the internal side wall and the outer side wall has optional clear plastic parts. The optional clear parts help a person to see the contents below without removing the lid-shaped container.

7. The enclosed mouse trap container according to claim 1, wherein the lid-shaped container is adapted to fit on a bucket container. In addition, the lid-shaped container can be used with an optional size-adaptor plate. The size-adaptor plate enables the same lid-shaped container to fit over various sized bucket containers.

8. The enclosed mouse trap container according to claim 1, wherein the lid-shaped container has a bait storage area along the floor distal to the distal end of plank.

9. The enclosed mouse trap container according to claim 1, wherein the lid-shaped container has the one-way swing door built-in within the short tunnel-shaped entrance. The short tunnel-shaped entrance or structure fitted with the one-way swing door is called the connector of the lid-shaped container. The one-way swing door is a simple mechanical swing door. The simple mechanical one-way swing door has two components; a main body and a pair of cylindrical tabs. Each tab has a cylindrical structure which helps to pivot at its axis while suspended within the walls of the tunnel-shaped structure. The short tunnel-shaped entrance or structure has a pair of holes on the tunnel walls providing the fitting space for the pair of cylindrical tabs of the swing door. The body of the swing door has similar shape to the cross-sectional area of the tunnel-shaped structure. The swing door is designed to cover the most of the cross-sectional areas of the tunnel-shaped structure. There are two ways of setting up the one-way swing doors depending on the types of tunnel-shaped entrance or structure used. If the tunnel-shaped entrance or structure has a step-like or bump-like features within its wall, then the swing door is placed directly against the step-like or bump-like features within the tunnel wall. The above set up allows the swing door to open in one direction only when mice pushes it as mice advance. At the same time the same set up would prevent mice from pushing the door swing open in the opposite direction because the door would not swing open due to the step-like or bump-like features within the tunnel walls. If the tunnel-shaped entrance or structure has no bump or step-like features within the wall, then the swing door is set at an angle within the tunnel-shaped entrance or structure, and the lower edges of the swing door rests on the internal surface of the tunnel-shaped entrance or structure. This way of set up also allows the swing door to open in one direction only when mice push it as mice advance. At the same time this setup would prevent mice from pushing the door swing open in the opposite direction. Therefore, both ways of setting up the swing doors within the tunnel-shaped entrance or the tunnel-shaped structure would prevent mice from escaping the trap while allowing mice to advance to next stages of traps.

10. The enclosed mouse trap container according to claim 1, wherein the tunnel-like structure or the entrance of the tunnel-shaped bridge has the following features. The tunnel-shaped bridge has the same swing door of claim 9 and has the same settings of swing door of claim 9. In other words, the tunnel-shaped bridge has the same one-way swing door and the same setup within its entrance or tunnel-shaped structure as the connector of the lid-shaped container.

11. The enclosed mouse trap container according to claim 1, wherein the tunnel-shaped bridge has a distal end which has a broad entrance at the ground level with graduated tapering configuration at the base of entrance.

12. The enclosed mouse trap container according to claim 1, wherein the tunnel-shaped bridge having optional clear plastic parts along its structure. This would enable a person to see the inside of the tunnel-shaped structure, the tunnel-shaped bridge.

13. The enclosed mouse trap container according to claim 1, wherein the outer container having one entrance each on three side walls of the outer container. Each entrance of the outer container has a tunnel-shaped structure which has the same one-way swing door built-in within the tunnel-shaped structure as described of claim 9. Each swing door within the tunnel-shaped structure or entrance has set up in a way it opens in one-direction only as described of claim 9. Each swing door has been positioned at an angle or positioned against the internal wall structure in a way which opens only in one directions as described of claim 9.

14. The enclosed mouse trap container according to claim 1, wherein the lid of outer container has optional features of two ways of opening the lid; partial opening of lid along the folding line of lid or opening the whole lid off. The lid has optional clear plastic parts so that a person may able to see the inside of the outer container without opening the lid.
